(19) United States
(12) Patent Application Publication
(10) Pub. No.: US 2014/0352551 A1
(43) Pub. Date: Dec. 4, 2014

(54) GRILL WITH ADJUSTABLE HEIGHT COOKING SURFACE AND FLAVOR DRAWER

(71) Applicant: The Grill Company, LLC, Columbia, SC (US)

(72) Inventors: John Ducate, Columbia, SC (US); Lincoln Sun, Kaohsiung City (TW)

(73) Assignee: The Grill Company, LLC, Columbia, SC (US)

(21) Appl. No.: 14/291,282

(22) Filed: May 30, 2014

Related U.S. Application Data
(60) Provisional application No. 61/829,682, filed on May 31, 2013.

(51) Int. Cl. A47J 37/07

(52) U.S. Cl. CPC A47J 37/0704; A47J 37/0713; A47J 2037/0795
USPC 99/339

(57) ABSTRACT

This invention is directed to a gas grill comprising: a firebox and frame; a vertically movable cooking surface so that the cooking surface can be vertically moved during cooking to control the cooking temperature; and a rack disposed under the cooking surface for receiving secondary fuel and having at least 50% of its area open so as not to dissipate heat from a primary heat source that is disposed under the cooking surface and rack for igniting the secondary fuel and providing heat to the cooking surface. The cooking surface can be a cooking assembly that includes a top cooking member having top “U” shapes and a bottom cooking member that has bottom inverted “U” shapes offset from the top “U” shapes so that heat from the primary heat source can travel upwards through the cook surface and grease can travel into the bottom inverted “U” shapes.

### FIELD OF THE INVENTION

This invention is directed toward an outdoor grill and more specifically, to a grill with a vertically adjustable cooking surface and flavor drawer. The present invention is preferably used outdoors and can have a primary gas heat source supplemented with wood, charcoal or other fuels or flavor items. Furthermore, the height between the heat source and the cooking surface can be dynamically adjusted by raising or lowering the cooking surface during cooking.

### BACKGROUND OF THE INVENTION

While there are various grilling styles and cooking methods, one style that has been rising in popularity is the Argentine style. Typically, the Argentine style grill has an adjustable height, sloped “V” grate cooking surface. The adjustable height of the Argentine grill cooking surface allows precise temperature control of the grilling meat to achieve uniformly cooked meats with a uniform doneness across the thickness of the meat. The sloped “V” grate cooking surface drains fat away from the fire, preventing flare-ups which could diminish the flavor of fine grilled meats.

In order to control the height between the cooking surface and the heat source, overhead pulley systems have been used to raise and lower the cooking surface. Even as the Argentine grill has been modernized, the apparatus to raise and lower the cooking surface still has maintained the overhead assembly. The pulley assembly is bulky and unnecessarily large thereby requiring a larger footprint for its use that, in many cases, exceeds the available area for a grill in a backyard area making the traditional Argentine grill not an option.

While some improvement has been made in the height adjusting assembly as shown in United States Patent Application Publication 2012/0288596, there still remain significant disadvantageous to the pulley and crank system. The foot print is significantly larger and the height requirements are greater. Another attempt to vary the height between the cooking surface and the heat source is to have a vertically movable heat source as shown in U.S. Pat. No. 5,878,739. However, this reference does not vary the cooking surface height, but only the heat source within the firebox.

Furthermore, the traditional Argentine grill includes a grease trough that is located at the front of the grill that will contain a hot liquid grease which poses a significant danger to users during and after cooking. During operation, the grease can spill, sizzle and otherwise injure the user of the traditional grill. Obviously, this is a significant disadvantage. Moreover, traditional grills do not include a grease trough thereby allowing grease to contact the heat source cause flare-ups.

Therefore, it is an object of the present invention to provide a cooking apparatus that has a variable height cooking surface.

It is another object of the present invention to provide for cooking with gas combined with a wood, charcoal, or other fuel source.

It is another object of the present invention to provide for cooking with gas combined with a wood, charcoal, or other fuel source without diffusing the primary heat source.

### SUMMARY OF THE INVENTION

The objects of the present invention are achieved by providing a gas grill comprising: a firebox attached to a frame; a vertically movable cooking surface carried by the frame so that the cooking surface can be vertically moved during cooking to control the cooking temperature; and, a rack disposed under the cooking surface for receiving secondary fuel and having at least 50% of its area open so as not to dissipate heat from a primary heat source that is disposed under the cooking surface and rack for igniting the secondary fuel and providing heat to the cooking surface.

The grill can include a handle connected to a linkage that is connected to a first scissor arm that is pivotally connected to a second scissor arm where the first and second scissor arms are operatively associated to the cooking surface so that when the handle is actuated, the cooking surface is raised and lowered. The cooking surface can be a cooking assembly that includes a top cooking member having top “U” shapes and a bottom cooking member that has bottom inverted “U” shapes offset from the top “U” shapes so that heat from the primary heat source can travel upwards through the cook surface and grease can travel into the bottom inverted “U” shapes.

A grease trough can be removable attached to said frame for catching grease transported from under the cooking surface by the bottom inverted “U” shapes and for directing the grease into a grease drain. The rack can include a carrying member for supporting the secondary fuel and a stabilizing member for restricting lateral movement of the secondary fuel. A portion of the carrying member can be disposed below the stabilizing members.

A secondary fuel drawer can be slidably attached to the frame for removing the rack from under the cooking surface so that the secondary fuel can be placed on the rack. Lifting handles can be attached to the cooking surface so that the cooking surface can be removed to allow placement of the secondary fuel on the rack.

A multi-purpose tool can be included for placing secondary fuel on the rack and for cleaning the bottom inverted “U” shapes of the cooking surface, the top “U” shapes and the grease trough. A redirectional tube can be removable carried by the frame for receiving grease from the drain and directing the grease into a grease pan. The redirectional tube can include a closed portion and a semi-closed portion where the closed portion is disposed upstream of the semi-closed portion. The cooking surface can be slanted forward and to one side so that the grease travels from the cooking surface into the bottom inverted “U” into the grease trough and into the grease drain.

The first scissor arm can include a minor arm attached to a major arm by a pivot. An ash pan can be disposed under the primary heat source carried by the secondary fuel drawer. A burner receiving area can be defined in the secondary fuel drawer, so that the ash pan is disposed under the primary heat source and the rack is disposed above the primary heat source when the secondary fuel drawer is closed without interfering with the primary heat source.

The grill can include a first scissor arm pivotally attached to a second scissor arm wherein the first scissor arm and the second scissor arm are slidably attached to the cooking surface; a linkage attached to the first scissor arm; a junction box attached to the linkage; a crank attached to the junction box; and a crank handle pivotally attached to the crank so that the crank handle can be positioned horizontally and used to raise and lower the cooking surface during cooking.

### DESCRIPTION OF THE DRAWINGS

The invention will be described in more detail from a reading of the following specification and by reference to the accompanying drawings, wherein an example of the invention is shown as follows:

FIGS. 1A and 1B are perspective views of aspects of the invention;

FIG. 2 is a perspective view of aspects of the invention;

FIG. 3A is a side view of aspects of the invention;

FIG. 3B is a perspective view of aspects of the invention;

FIG. 4 is a front view of aspects of the invention;

FIG. 5A is a perspective side view of aspects of the invention;

FIG. 5B is a side view of aspects of the invention; and

FIG. 6 is a perspective view of aspects of the invention.

### DESCRIPTION OF THE INVENTION

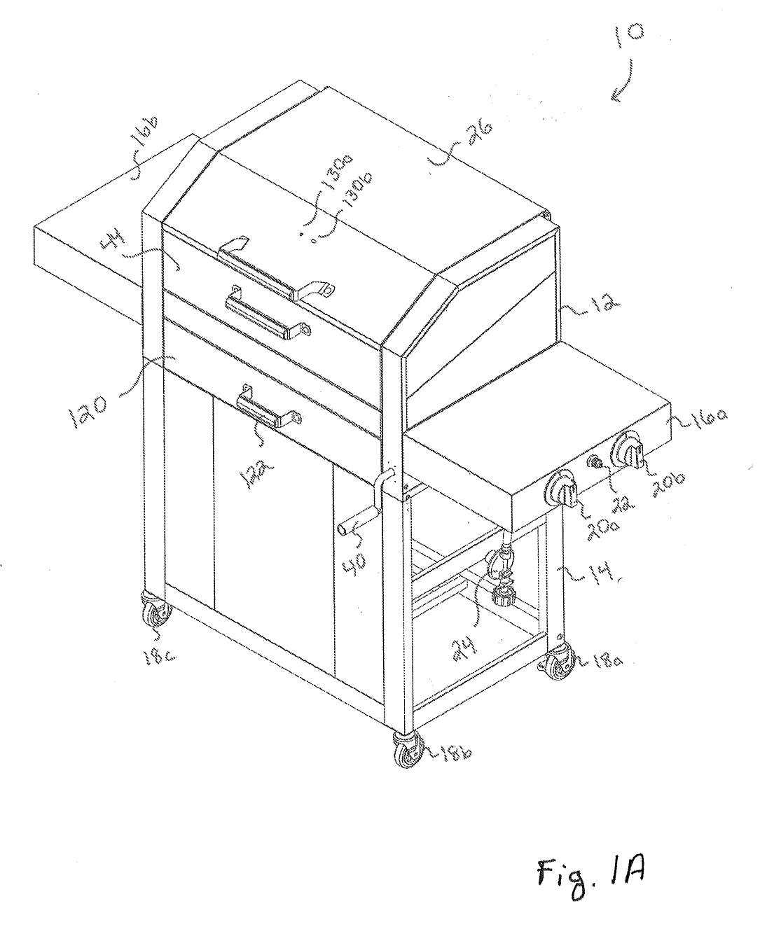

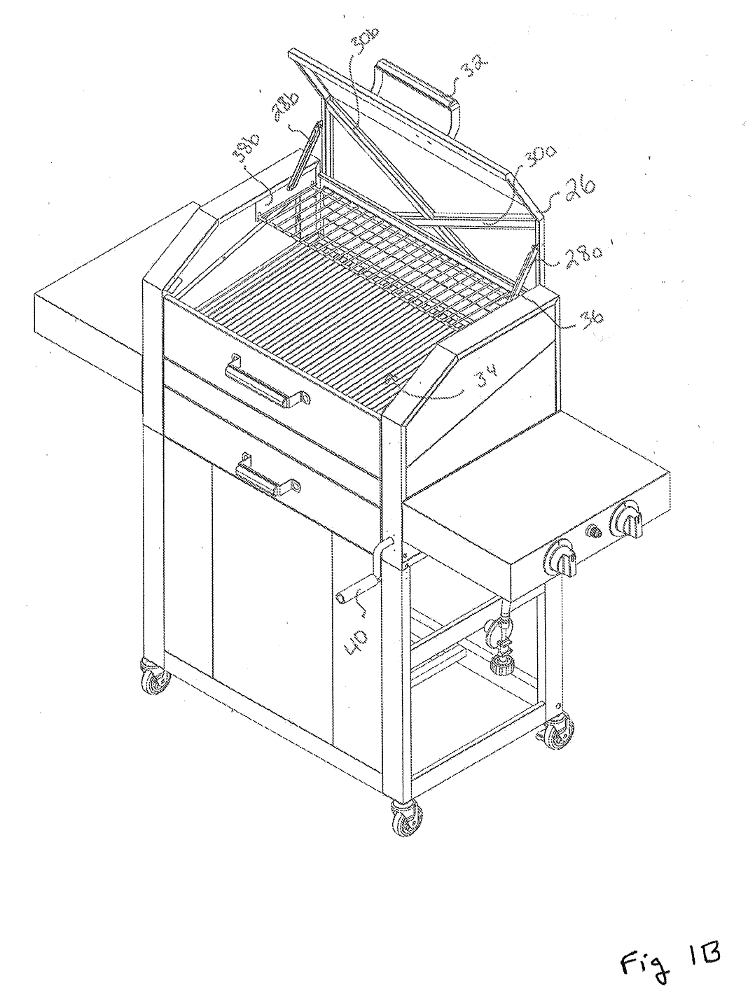

Referring to FIG. 1A, the grill 10 is shown including a firebox 12 carried by a frame 14. The frame can include side tables 16a and 16b connected to the left and right sides of the firebox. Casters 18a through 18d (not shown) can be attached to the frame to allow the frame to be moved about. The casters can have a locked and unlocked position. Gas controls 20a and 20b can be located on one of the tables or otherwise carried by the frame and control the gas flow from a gas source attached to a regulator 24. In one embodiment, the gas burner is used only to ignite the other fuel (i.e. wood, coal, lava rocks, etc) and the gas burner is turned off once the other fuel sources causes the heat source to reach a desired temperature. An igniter 22 can be carried on the frame and can be used to ignite the gas from a gas source. A crank that can include a crank handle 40 is attached to an elevator assembly and extends out of the frame allowing the elevator assembly to be actuated. In one embodiment, the temperature of the cooking surface is controlled by raising and lowering the cooking surface closer to or away from the heat source.

In one embodiment, lid 26 can be pivotally attached to the firebox by a dual pivot hinge. The dual pivot hinge can include a first pivot, a second pivot and a hinge arm. This arrangement allows the lid to be opened up and rearwards so that the lid is arranged vertically at the rear of the firebox.

The lid can include opening 130a and 130b for attaching articles such as thermometers for conveying the internal temperature in the firebox, a label plate bearing the manufactures brand, and other such articles.

Referring to FIG. 1B, lid handle 32 and lid support arms 28a and 28b can be included to support the lid and to guide its motion between the open and closed position. Reinforcement beams 30a and 30b can be included in the lid as well as lid handle 32. A cooking surface 34 can be carried by the frame as can a warming surface 36. The warming surface can be removably supported by vertical plates 38a (not shown) and 38b that are carried by the firebox.

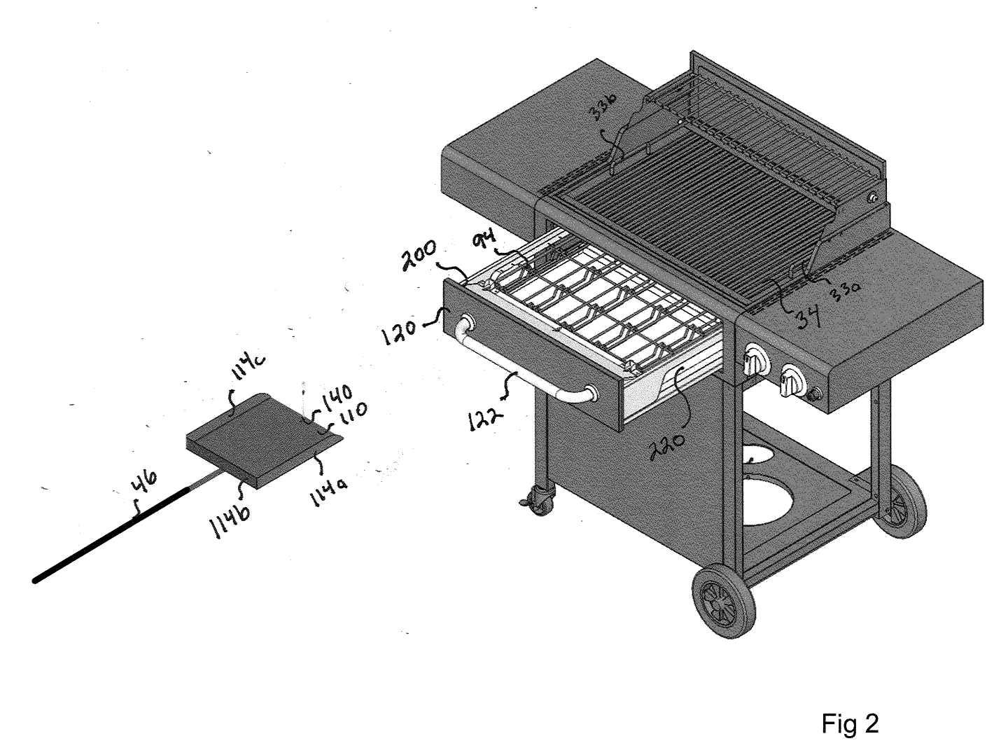

Referring to FIG. 2, a secondary fuel drawer 200 is shown in an open position so that secondary fuel can be placed in the drawer. Secondary fuel can be added to the drawer and when the drawer is closed, the secondary fuel is disposed above the burner (primary heat source) and can provide additional heat and supplement the flavor of the items being cooked. In one embodiment, the secondary drawer includes a rack 94 that supports the secondary fuel without dispersing the heat from the burners or primary fuel source. By providing ample sufficient voids in the rack, heat from the burners can reach the cooking surface without unnecessary interference or dissipation. In one embodiment, at least 50% of the rack is open or void. In one embodiment, at least 66% of the rack is void. In one embodiment, at least 75% of the rack is void. In one embodiment, the ratio of the sum of the carrying members and the stabilizing members and the width of the cooking surface is in the range of 1:2 to 1:4.

In one embodiment, the drawer can include a front panel 120 that can rotate downward. The drawer can include a handle 122 that can be used to open the front panel. Fuel can be passed to the secondary fuel drawer through the front panel (access door) using a tool such as multi-purpose tool 46 without necessarily having to open the drawer. The multi-purpose tool can include a shovel at one end to assist in adding fuel to the heat source. The multi-purpose tool can include a shovel end 110. The shovel end can have walls 114a through 114c. In one embodiment, the left and right walls are a squared edge with another embodiment including the walls having a rounded leading edge. The leading edge of the shovel can be used to clean the bottom cooking surface by scraping the “U” shaped members of the cooking surface with the leading edge. The leading edge of the shovel can be used to clean the grease trough by scraping the “U” shaped members of the grease trough with the leading edge. The multi-purpose tool can be stored on a hook that is received into the handle so that the multi-purpose tool is carried by the frame. The shovel can include a match opening 140 for receiving a match that can be used to light the gas burner.

In one embodiment, the cooking surface can include lifting handles 33a and 33b so that the cooking surface can be removed and secondary fuel can be added to the underlying rack. Lifting the cooking surface can be an alternative to raising the cooking surface to provide for an access area 214 to place secondary fuel on the rack. In one embodiment, an ash pan 220 can be included under the rack so that ashes can be collected and later disposed of.

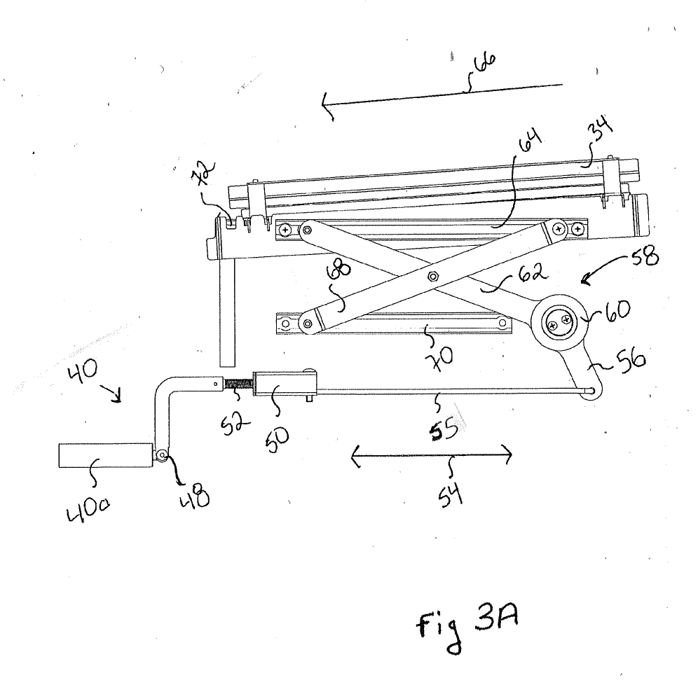

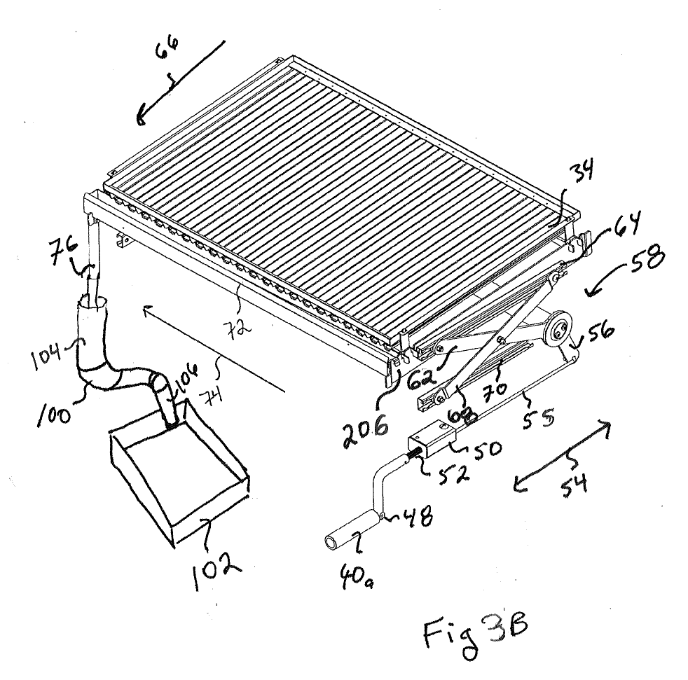

Referring to FIG. 3A, crank handle 40 that is attached to a junction box 50 by threaded portion 52. When the handle is rotated, the junction box causes linkage 55 to move in direction shown as 54. The linkage causes the minor arm 56 of first scissor arm 58 to rotate around pivot 60, which in turn causes major arm 62 to move in an upward or downward direction. The distal end of the first scissor arm can travel in an upper rail 64 that is carried by the cooking surface. In one embodiment, the upper rail and lower rail are carried by the cooking surface frame 206. In one embodiment, the cooking surface has a downward slant 66 in relation to the upper rail allowing grease to travel in a downward direction. A second scissor arm 68 is pivotally attached to the first scissor arm so that when the first scissor arm moves upwards, the second scissor arm's distal end also moves upwards, thereby causing the cooking surface to rise above the heat source. The distal end of the first and second scissor arms are attached in a lower rail 70 carried by the frame and, in one embodiment, attached to an inner surface of the firebox. The distal end of the second scissor arm can be attached to the upper rail. When the crank is actuated, minor arm 56 can travel forward, thereby raising the scissors and the cooking surface.

A scissor assembly is used to raise and lower the cooking surface and includes the crank handle, linkage between the crank handle the first scissor arm that is pivotally connected to the second scissor arm that is connected to the cooking surface so that the cooking surface is raised and lowered when the crank is actuated.

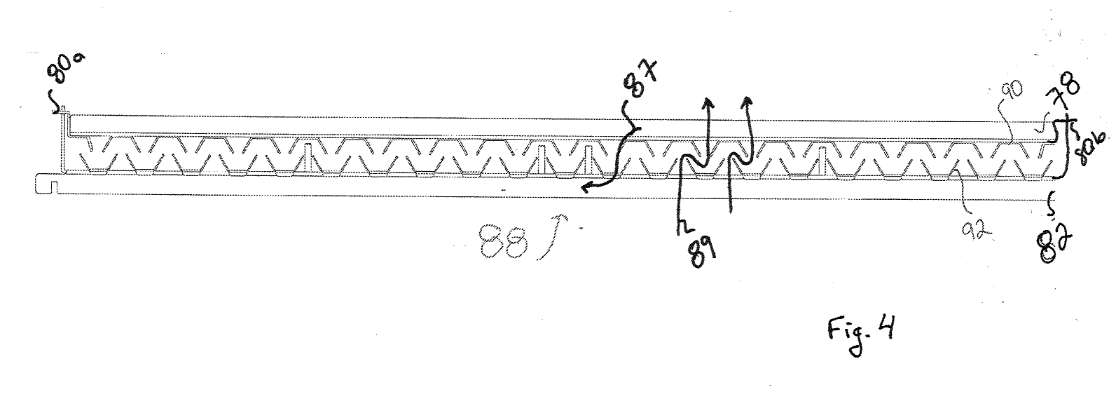

A grease trough can be disposed under the lower end of the cooking surface as shown in FIGS. 3A and 3B. The grease trough can have a slight downward slope in direction 74 allowing grease to run down the trough into a grease drain 76. The grease drain can be received into a redirectional tube 100 that is carried by the frame and can be attached to the inner surface of the firebox. The re-directional tube redirects hot grease from the grease trough to a pan 102. The pan can be removably attached to the frame allowing the grease, preferably once it has cooled, to be disposed of. The grease is directed into the troughs of the “U” shapes 92 (FIG. 4) of the bottom cooking surface 82 (FIG. 4) and then on the grease trough. The grease is then directed on the grease drain and then into the pan by the redirectional tube 100.

The bottom cooking surface is arranged to allow grease and other material to be directed to the grease trough and into the grease drain. The grease trough can be removed for cleaning as the grease drain is removably received into the redirectional tube. The re-directional tube can include a closed portion 104 that defines an opening in the redirectional tube and a semi-closed position 106 that redirects grease and into the pan.

Referring to FIG. 4, a cooking assembly can include a top cooking member 78 and a bottom cooking member 82 to make a cooking assembly 88. The top cooking portion can be supported by 80a through 80d. The bottom cooking portion can be included in the cooking surface and supported by a cooking surface frame. The top cooking surface includes a plurality of top “U” shapes 90 spaced about the top cooking surface. In one embodiment the “U” shapes have angled corners. The bottom cooking surface includes a plurality of bottom inverted “U” shapes 92 that are alternating under the top portion “U’ shapes. This arrangement allows the grease from the cooking surface to run down the top “U” shapes and into the trough of the bottom inverted “U” shapes so that the grease will then run into the grease trough and not onto the burner or other heat source, thereby reducing or eliminating a flare-up as shown by grease path 87. The heat source can heat the cooking assembly to cook items as well as allow heat to travel through paths 89 allowing heated air to contact the cooking items.

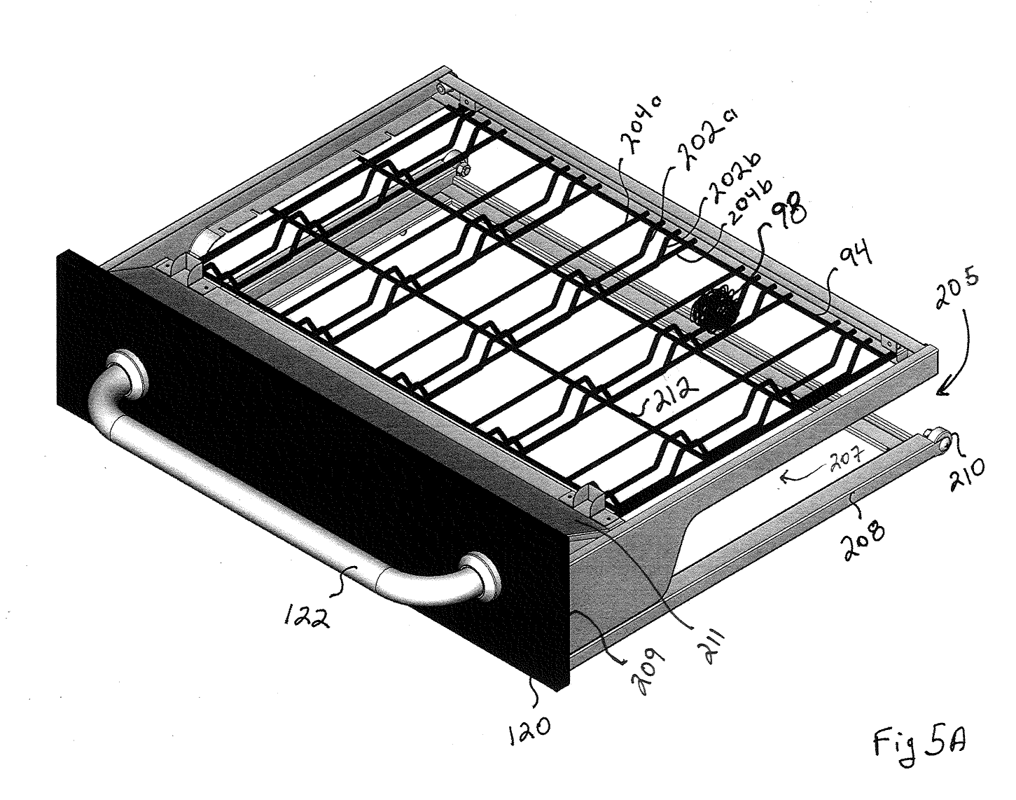

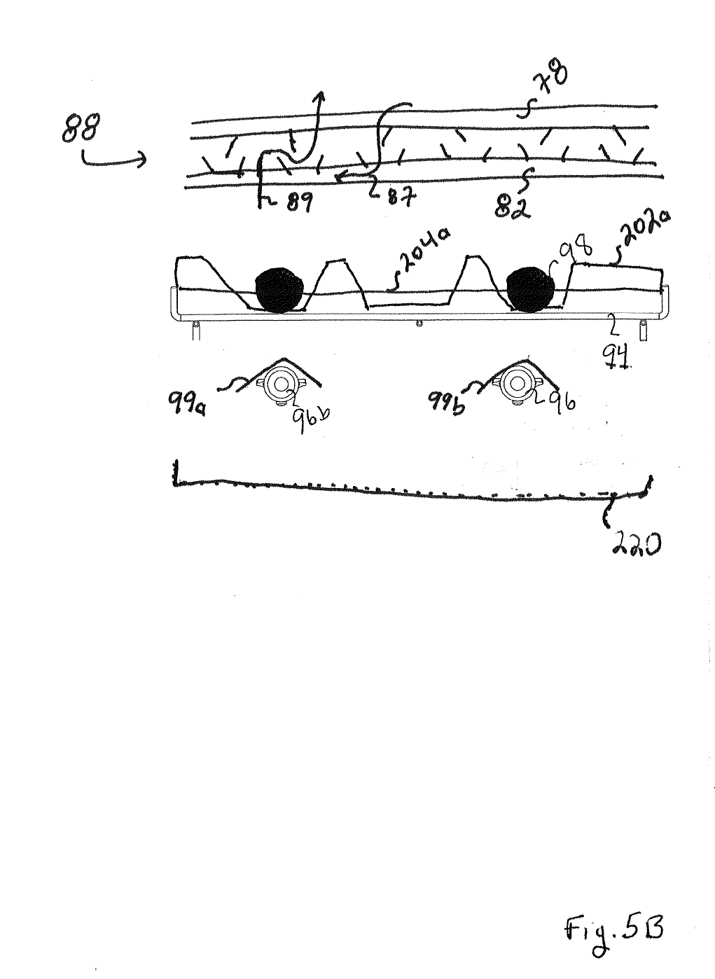

Referring to FIG. 5A and 5B, the cooking assembly can be disposed in the firebox above rack 94 that supports a secondary fuel 98 such as coal, wood, or lava rocks. The rack can be disposed above a burner 96 that is attached to an external fuel source, such as propane, to initially ignite the heat source on the rack, regulate the heat source on the rack or add to the heat produced by the heat source. The rack can include carrying members 202a and 202b to support the secondary fuel. Stabilizing members 204a and 204b are included so that the fuel source is supported by the carrying members and lateral motion is hampered by the stabilizing members. Lateral supports 212 can be included in the rack to provide the strength and support for secondary fuels without causing the heat from the burner to dissipate.

By using the carrying members and stabilizing members, the heat from the primary fuel source (e.g. burner) is not dissipated and efficiency is not reduced when providing heat to the cooking surface. The secondary fuel drawer can include a rack frame 205 including a runner 208 and roller 210 allowing the drawer to slide in and out from the grill. The ash pan can be carried by the runner and can be disposed below the burner. In the embodiment where the ash pan is disposed below the burners, burner covers 99a and 99b can be disposed above the burners to protect the burners from falling ash or other materials. The ash pan can be removed from the firebox or the frame to dispose of the collected ash. A burner receiving area 207 can be defined by the rack, ash pan, and front panel 209 of the secondary fuel drawer so that the burner is received in the burner receiving area allowing the drawer to close without interfering with the burner. A deflection plate 211 can be included in the secondary fuel drawer so that in the event that the drawer is not fully closed and a liquid or solid drops onto the partially opened drawer, the liquid or solid is deflected into the drawer and into the ash pan.

The fuel 98 can be placed directly on the rack above the burner. In one embodiment, the burner is a “U’ shaped burner that includes a single gas inlet. In one embodiment, the burner includes a right burner 96a and a left burner 96 each with a gas inlet where the gas flow and temperature of each burner can be controlled independently.

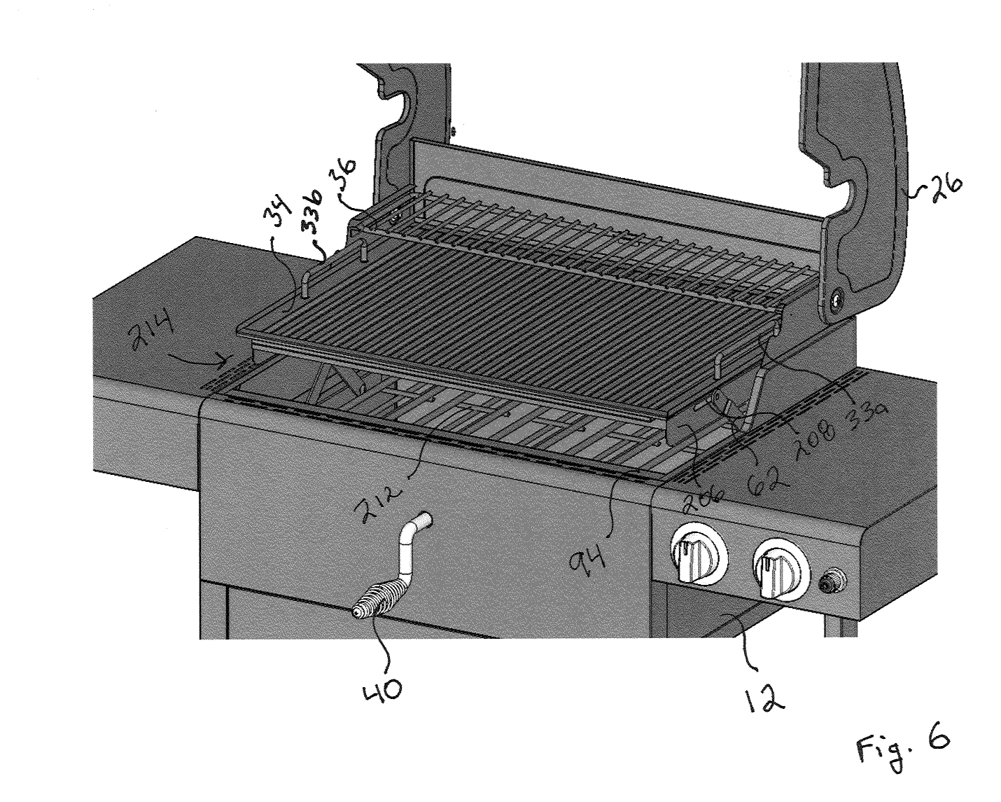

Referring to FIG. 6, one embodiment is shown with the rack carried by the frame in the firebox and disposed under the cooking surface. In this embodiment, secondary fuel can be placed on the rack when the cooking surface is raised so that access area 214 is provided. The secondary fuel can be inserted onto the rack using the multi-purpose tool.

In this embodiment, the major arm 62 can be slidably attached to a cooking surface frame 206 that includes a slot 208 to receive the major support arm. The minor support arm can also be slidably attached to the cooking surface frame so that when the crank is actuated, the cooking surface can be moved vertically. A plurality of lateral supports 212 can be attached to the rack spaced laterally along the rack.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to,” or other like phrases in some instances shall not be read to mean that the narrower case is intended or required in instances where such broadening phrases may be absent.

What is claimed is:

1. A gas grill comprising:
a firebox attached to a frame;
a vertically movable cooking surface carried by the frame so that the cooking surface can be vertically moved during cooking to control the cooking temperature; and,
a rack disposed under the cooking surface for receiving secondary fuel and having at least 50% of its area open so as not to dissipate heat from a primary heat source that is disposed under the cooking surface and rack for igniting the secondary fuel and providing heat to the cooking surface.

2. The grill of claim 1 including a handle connected to a linkage that is connected to a first scissor arm that is pivotally connected to a second scissor arm where the first and second scissor arms are operatively associated to the cooking surface so that when the handle is actuated, the cooking surface is raised and lowered.

3. The grill of claim 1 including a cooking assembly that includes a top cooking member having top “U” shapes and a bottom cooking member that has bottom inverted “U” shapes offset from the top “U” shapes so that heat from the primary heat source can travel upwards through the cook surface and grease can travel into the bottom inverted “U” shapes.

4. The grill of claim 1 including a grease trough removable attached to said frame for catching grease transported from under the cooking surface by the bottom inverted “U” shapes and for directing the grease into a grease drain.

5. The grill of claim 1 wherein the rack includes a carrying member for supporting the secondary fuel and a stabilizing member for restricting lateral movement of the secondary fuel.

6. The grill of claim 5 wherein a portion of the carrying member is disposed below the stabilizing members.

7. The grill of claim 1 including a secondary fuel drawer slidably attached to the frame for removing the rack from under the cooking surface so that the secondary fuel can be placed on the rack.

8. The grill of claim 1 including lifting handles attached to the cooking surface so that the cooking surface can be removed to allow placement of the secondary fuel on the rack.

9. A gas grill comprising:
a firebox attached to a frame having a primary heat source;
a scissor assembly attached to the frame;
a cooking surface operatively associated with the scissor assembly so that the cooking surface is vertically movable during cooking to control the cooking temperature; and
a rack disposed under the cooking surface and above the primary heat source for receiving secondary fuel wherein the rack does not dissipate heat from the primary heat source.

10. The grill of claim 9 including a secondary fuel drawer slidably attached to the frame for removing the rack from under the cooking surface so that the secondary fuel can be placed on the rack.

11. The grill of claim 9 including a cooking assembly that includes a top cooking member having top “U” shapes and a bottom cooking member that has bottom inverted “U” shapes offset from the top “U” shapes so that heat from the primary heat source can travel upwards through the cook surface and grease can travel into the bottom inverted “U” shapes.

12. The grill of claim 11 including a multi-purpose tool for placing secondary fuel on the rack and for cleaning the bottom inverted “U” shapes of the cooking surface.

13. The grill of claim 11 including:
a grease trough removably carried by the frame for directing grease from the bottom inverted “U” shapes into a grease drain; and
a redirectional tube removable carried by the frame for receiving grease from the drain and directing the grease into a grease pan.

14. The grill of claim 13 wherein the redirectional tube includes a closed portion and a semi-closed portion where the closed portion is disposed upstream of the semi-closed portion.

15. The grill of claim 13 wherein the cooking surface is slanted forward and to one side so that the grease travels from the cooking surface into the bottom inverted “U” into the grease trough and into the grease drain.

16. The grill of claim 9 wherein the first scissor arm includes a minor arm attached to a major arm by a pivot.

17. The grill of claim 9 including:
a secondary fuel drawer that is slidably attached to the frame for removing the rack from under the cooking surface so that the secondary fuel can be placed on the rack;
an ash pan disposed under the primary heat source carried by the secondary fuel drawer; and
a burner receiving area defined in the secondary fuel drawer so that the ash pan is disposed under the primary heat source and the rack is disposed above the primary heat source when the secondary fuel drawer is closed without interfering with the primary heat source.

18. A gas grill comprising:
a firebox attached to a frame;
a vertically movable cooking surface carried by the frame disposed above the firebox so that the cooking surface can be vertically moved during cooking to control the cooking temperature;
a primary heat source disposed under the rack for igniting the secondary fuel and providing heat to the cooking surface; and,
a secondary fuel drawer slidably attached to the frame and having a rack disposed under the cooking surface for receiving secondary fuel wherein the rack does not dissipate heat generated by the primary heat source.

19. The grill of claim 18 including:
an ash pan carried by the secondary fuel drawer; and
a burner receiving area defined in the secondary fuel drawer so that the ash pan is disposed under the primary heat source and the rack is disposed above the primary heat source when the secondary fuel drawer is closed and the secondary fuel drawer does not interfere with the primary heat source.

20. The grill of claim 18 including:
a first scissor arm pivotally attached to a second scissor arm wherein the first scissor arm and the second scissor arm are slidably attached to the cooking surface;
a linkage attached to the first scissor arm;
a junction box attached to the linkage;
a crank attached to the junction box; and
a crank handle pivotally attached to the crank so that the crank handle can be positioned horizontally and used to raise and lower the cooking surface during cooking.
